(19) United States
(12) Patent Application Publication
(10) Pub. No.: US 2022/0292353 A1
(43) Pub. Date: Sep. 15, 2022

(54) Training Dataset, Training and Artificial Neural Network for the State Estimation of a Power Network

(71) Applicant: Siemens Aktiengesellschaft, München (DE)

(72) Inventors: Mathias Duckheim, Erlangen (DE); Thomas Werner, Rednitzhembach (DE); Manja Babea Schölling, Düsseldorf (DE)

(73) Assignee: Siemens Aktiengesellschaft, München (DE)

(21) Appl. No.: 17/694,294

(22) Filed: Mar. 14, 2022

(30) Foreign Application Priority Data
Mar. 15, 2021 (EP) 21162647.8

(51) Int. Cl. G06N 3/08

(52) U.S. Cl. CPC G06N 3/08; H02J 13/00001

(57) ABSTRACT

A method for creating for training an artificial neural network for a state estimation of a power network from a first training dataset, said dataset comprising a plurality of training pairs, each pair formed by a measurement dataset and an associated state of the power network, and the measurement dataset comprises complex apparent powers associated with the power network. The method may include: determining a first training pair, an associated measurement dataset and state with an error greater than or equal to a defined error limit; calculating a second state using a load flow calculation with a complex apparent power modified in comparison with the first dataset; calculating a second measurement dataset from the second state using a measurement model; and creating the second training dataset from the first by adding a second training pair formed from the second measurement dataset and the associated second state.

### CROSS-REFERENCE TO RELATED APPLICATIONS

This application claims priority to EP Application No. 21162647.8 filed Mar. 15, 2021, the contents of which are hereby incorporated by reference in their entirety.

### TECHNICAL FIELD

The present disclosure relates to power networks. Various embodiments include methods for creating a training dataset, methods for training an artificial neural network, artificial neural networks, and/or methods for state estimation in a power network.

### BACKGROUND

A state estimation of an electrical supply network (power network) relates to a determination, which is as complete and consistent as possible, of the state of the power network from a plurality of measurements. The state of a power network is characterized here by the voltages and angles on its network nodes. Measurements have measurement deviations which are essentially caused by communication delays and/or configuration errors. The state determined in a state estimation thus corresponds to an estimated value of the actual real state of the power network. In other words, the state which, in the sense of an optimization problem, best matches the measurements or measured values and the physical interrelationships in a power network is determined by means of a state estimation. Even if only an estimation of the actual state can be achieved, the determined, i.e. the estimated, state of the power network forms the basis for a plurality of higher-level network applications, for example security reports, voltage controls and/or preventive and corrective SCOPF (Security Constrained Optimal Power Flow).

The state of a power network is time-dependent, so that a state estimation is typically performed in regular time segments. Known monitoring, control and data acquisition systems (Supervisory Control and Data Acquisition; abbreviated as SCADA), for example, have a time segment of around one minute for a state estimation. In other words, the technical challenge lies in the fact that the state estimation must be performed in real time so that the higher-level network applications can be used and completed. A further technical challenge lies in the fact that the state estimation carried out in real time must similarly have a sufficient accuracy.

In view of said time factor, the use of an artificial neural network (ANN) may be advantageous for the state estimation. However, in contrast to conventional methods, such as, for example, a state estimate by means of a weighted least square (WLS) method, its reliability is doubtful. An estimation of the reliability of the neural network is enabled, for example, by determining a maximum error or estimation error of a trained machine-based learning model via an independent test dataset. However, the reliability of the artificial neural network essentially depends on the training dataset by means of which said network has been trained, i.e. taught.

### SUMMARY

The teachings of the present disclosure include an improved training dataset for an artificial neural network, said artificial neural network being provided for a state estimation of a power network. For example, some embodiments include a method for creating a second training dataset for training an artificial neural network designed for a state estimation of a power network (1) from a provided first training dataset, said second training dataset comprising a plurality of training pairs, wherein each of the training pairs is formed by a measurement dataset and an associated state of the power network (1), and the respective measurement dataset comprises at least complex apparent powers associated with the power network, characterized at least by the steps of: (S1) determining at least one first training pair and an associated first measurement dataset and first state, the first state of which has an error greater than or equal to a defined error limit compared with a training of the artificial neural network by means of the first training dataset; (S2) calculating a second state of the power network by means of a load flow calculation based on at least one complex apparent power modified in comparison with the complex apparent power of the first measurement dataset; (S3) calculating a second measurement dataset from the calculated second state by means of a measurement model of the power network; and (S4) creating the second training dataset from the first training dataset by adding a second training pair formed from the second measurement dataset and the associated second state.

In some embodiments, the training pairs of the first training dataset are generated in each case by a load flow calculation.

In some embodiments, the training pairs are generated from synthetically generated complex apparent powers by means of a respective load flow calculation, wherein the complex apparent powers are generated from historical and/or synthetic time series for generation and consumption.

In some embodiments, the at least one complex apparent power of the first measurement dataset is modified by means of an addition of normally distributed random numbers.

In some embodiments, the at least one complex apparent power of the first measurement dataset is modified by means of a scaling.

In some embodiments, one of the complex apparent powers of the first measurement dataset is modified if its amount is greater than or equal to a defined threshold value.

In some embodiments, the errors associated with the states of the first training dataset are determined by a training of the artificial neural network with the first training dataset.

In some embodiments, the first training dataset is divided into two partial training datasets in order to determine the errors, wherein the first partial training dataset is used to train the artificial neural network, and the second partial training dataset is used to evaluate the states determined by the training.

In some embodiments, the complex apparent powers are formed by active powers and reactive powers associated with the network nodes (41, 42).

In some embodiments, the first measurement dataset and/or second measurement dataset is/are formed by voltages, currents, active powers and/or reactive powers associated with the network nodes (41, 42) and/or with lines of the power network (1).

In some embodiments, the state of the power network (1) is formed by voltages and angles on one or more network nodes (41, 42) of the power network (1).

As another example, some embodiments include a method for training an artificial neural network for a state estimation of a power network (1), characterized in that the artificial neural network is trained by means of a training dataset as described herein.

As another example, some embodiments include an artificial neural network for a state estimation of a power network which has measurement values associated with the power network (1) as inputs and the estimated state of the power network (1) to be determined by the state estimation as output, characterized in that the artificial neural network is trained as described herein.

As another example, some embodiments include a method for the state estimation of a power network by means of an artificial neural network which has measurement values associated with the power network (1) as inputs and the estimated state of the power network (1) to be determined by the state estimation as output, characterized in that an artificial neural network as described herein is used as the artificial neural network.

In some embodiments, measured voltages, currents, active powers and/or reactive powers associated with network nodes (41, 42) and/or with lines of the power network (1) are used as measurement values.

### BRIEF DESCRIPTION OF THE DRAWINGS

Further advantages, features, and details of various embodiments of the teachings herein are set out in the example embodiments described below and with reference to the drawings. In the drawings:

FIG. 1 shows schematically a flow diagram of a method incorporating teachings of the present disclosure; and

FIG. 2 shows schematically a possible representation of a critical training pair.

Similar, equivalent, or similarly acting elements can be denoted with the same reference numbers in one of the figures or in the figures.

### DETAILED DESCRIPTION

The methods described in the present disclosure may be used for creating a second training dataset for training an artificial neural network designed for a state estimation of a power network from a provided first training dataset, said second training dataset comprising a plurality of training pairs, wherein each of the training pairs is formed by a measurement dataset and an associated state of the power network, and the respective measurement dataset comprises at least complex apparent powers associated with the power network, is characterized at least by the following steps:
determining at least one first training pair and an associated first measurement dataset and first state, the first state of which has an error greater than or equal to a defined error limit compared with a training of the artificial neural network by means of the first training dataset;
calculating a second state of the power network by means of a load flow calculation based on at least one complex apparent power modified in comparison with the complex apparent power of the first measurement dataset;
calculating a second measurement dataset from the calculated second state by means of a measurement model of the power network; and
creating the second training dataset from the first training dataset by adding a second training pair formed from the second measurement dataset and the associated second state.

The artificial neural network can be abbreviated below as ANN.

A training pair (zₜ, xₜ) or a training dataset is characterized by a measurement dataset zₜ and an associated state xₜ of the power network. The fundamental time-dependency of the measurement dataset and the associated states is characterized by the index t. However, the index t is not written out below for the sake of clarity.

A state of the power network is formed by the voltages Uₙ and angles δₙ on the network nodes n=1, . . . , N of the power network, i.e. xₜ=(U_{t,n}, δ_{t,n}), wherein the abbreviating notation (U_{t,n}, δ_{t,n})=(U_{t,1}, . . . , U_{t,N}, δ_{t,1}, . . . , δ_{t,N}) is used. This abbreviating notation is also used for further quantities, in particular the measurement dataset.

A measurement dataset comprises the complex apparent powers Sₙ=Pₙ+iQₙ=(Pₙ, Qₙ) on the network nodes of the power network. Here, Pₙ is the node active powers and Qₙ the reactive powers of the network node n. The apparent power is defined by the amount of the complex apparent power. The measurement dataset comprises the complex apparent powers in the sense that they can be obtained from the respective measurement dataset or can be determined therefrom, for example from active power and reactive power.

The measurement dataset thus forms, for example, a measurement vector z=(Pₙₘ, Qₙₘ, Pₙ, Qₙ, Uₙ, δₙ), where Pₙₘ denotes the active powers and Qₙₘ the reactive powers of the lines (active power and reactive power flows), Pₙ denotes the node active powers, Qₙ the node reactive powers, Uₙ the node voltages and δₙ the node angles of the power network.

The artificial neural network is or has been trained by means of the first training dataset. Measurement datasets are fed here to the ANN. The ANN determines an associated state of the power network from a fed measurement dataset. The states determined by the ANN have a respective error compared with a test dataset or an evaluation dataset. The first training dataset can comprise the test dataset, so that the training is performed as a whole (training and test) by means of the first training dataset. However, the training dataset and the test dataset are typically two separate or two different datasets.

In some embodiments, the training pairs, in particular of a validation dataset or test dataset, are determined which have an error greater than or equal to a defined error limit compared with the training of the ANN or after the training of the ANN by means of the first training dataset. In other words, training pairs with a comparably substantial error are determined.

In some embodiments, a second state of the power network is calculated by means of a load flow calculation (power system simulator) based on at least the complex apparent power modified in comparison with the complex apparent power of the first measurement dataset. In other words, the complex apparent power associated with a training pair determined in the first step is numerically modified, as a result of which a new complex apparent power is formed. A new state, the second state, is calculated from this new complex apparent power by means of the load flow calculation. The numerical modification of the apparent power of the determined training pair or of the associated determined measurement dataset can be carried out by modifying its real component (active power), its imaginary component (reactive power), and/or a combination of said modifications.

In some embodiments, a second measurement dataset is calculated from the calculated second state by means of a measurement model of the power network. In other words, the measurement dataset associated with the second state, i.e. a new measurement dataset, is determined. This is done by means of the measurement model of the power network which is formed, for example, by a measurement model function zₜ=h(xₜ)+ϵₜ with the measurement error term ϵₜ. The measurement errors can be normally distributed. The measurement model function is typically non-linear wherein, however, a linear measurement model matrix H with h(x)=Hx can be provided. The measurement model or the measurement model function is characterized in that it can serve to determine a measurement dataset from a state. The determined second measurement dataset, together with the associated second state, forms a new training pair, i.e. the second training pair.

In some embodiments, the training pair formed in this way is added to the first training dataset. In other words, the first training dataset is extended by adding the new, in this sense synthetically generated, training pair to the second training dataset. The ANN or a further ANN can again be trained by means of the second training dataset extended in comparison with the first training dataset.

In some embodiments, the second training dataset has more data for critical scenarios, i.e. for training pairs which have a comparatively substantial error, through its synthetic extension by means of the newly generated second training pair. As a result, the accuracy of the artificial neural network trained by means of the second training dataset can similarly be improved for critical and therefore typically underrepresented events/scenarios. The creation of the second training dataset is therefore based on the technical consideration of providing further data for training the ANN for scenarios in which the ANN determines comparatively poor results (error greater than the defined error limit), which are furthermore typically rare. In other words, the second training dataset according to the invention comprises more data in the worst cases (error greater than the defined error limit), so that the accuracy of a correspondingly trained artificial neural network is improved in these critical cases.

In some embodiments, a long and time-consuming collection of data for rare events, i.e. rare or underrepresented training pairs, is not required. The training pairs can be generated synthetically according to the present invention. Furthermore, the selection of suitable training data is simplified, since training data which take account of application-critical cases themselves are provided by the present teachings. A corresponding state estimation based on a correspondingly trained artificial neural network can thus be implemented more quickly and more simply for existing power networks. In particular, the costs for commissioning state estimations of this type are thereby similarly significantly reduced. Furthermore, the artificial neural network trained according to the second training dataset can be used for further technical applications in which robust, machine-based learning models are required, for example for security reports, voltage controls and/or preventive and corrective SCOPF (Security Constrained Optimal Power Flow).

In some embodiments, a method for training an artificial neural network for a state estimation of a power network is characterized in that the artificial neural network is trained by means of a training dataset (second training dataset) according to the present invention and/or one of its designs. The artificial neural network for a state estimation of a power network which has measurement values associated with the power network as inputs and the estimated state of the power network to be determined by the state estimation as output is characterized in that the artificial neural network is trained according to the methods described herein.

In some embodiments, a method for the state estimation of a power network by means of an artificial neural network which has measurement values associated with the power network as inputs and the estimated state of the power network to be determined by the state estimation as output is characterized in that an artificial neural network incorporating the teachings herein is used as the artificial neural network. The state estimation is therefore based on captured measurement values and in this sense actually captured measurement data.

In some embodiments, the training pairs of the first training dataset are generated in each case by means of a load flow calculation. In other words, even the first training dataset is an in this sense synthetically generated dataset.

In some embodiments, the training pairs are generated from synthetically generated complex apparent powers by means of a respective load flow calculation, wherein the complex apparent powers have been or are generated from historical and/or synthetic time series for generation and consumption. In other words, the associated complex feed-in or complex feed-out apparent powers are first determined for realistic time series of the power generation and/or power consumption (and also storage) within the power network. The time series can be historical and/or synthetically generated here. The time series are generated or provided, for example, by synthetic demand time series of photovoltaic power installations, wind power installations, industrial plants, office complexes and/or the like. As a result, an associated complex apparent power S_{t,n}=(P_{t,n}, Q_{t,n}) can be determined for a plurality of network nodes of the power network, in particular for each network node of the power network. A state of the power network is then calculated in turn by means of a load flow calculation F_{PF}:S_{t,n}→(U_{t,n}, δ_{t,n}) from these complex apparent powers. As a result, an actual or a true state xₜ=(U_{t,n}, δ_{t,n}) of the power network is symbolically determined. The measurement dataset zₜ associated with this state xₜ can then be determined by means of the model measurement function by zₜ=h(xₜ)+ϵₜ. The training pairs (zₜ, xₜ) of the first training dataset can be generated as a result.

In some embodiments, the first training dataset may comprise at least 100, e.g. at least 1000 training pairs.

In some embodiments, at least one complex apparent power of the first measurement dataset is modified by means of an addition of normally distributed random numbers. In other words, at least one apparent power of a network node, e.g. a plurality of apparent powers of associated pluralities of network nodes, is modified by Sₜ→Sₜ+ΔS with ΔS normally distributed. This results in the new apparent power S′ₜ=Sₜ+ΔS on which the load flow calculation according to the second step is based. As a result, according to the distribution of ΔS, a plurality of states and therefore a plurality of training pairs can be added to the second training dataset for the critical scenario Sₜ.

In some embodiments, the at least one complex apparent power of the first measurement dataset can preferably be modified by means of a scaling. In other words, in this case, α=1−β, where β measures the deviation from the original complex apparent power. βϵ may be [0,0.2], i.e. a maximum modification/deviation of 20 per cent is used.

In some embodiments, one of the complex apparent powers of the first measurement dataset is modified if its amount is greater than or equal to a defined threshold value. In other words, the complex apparent powers may be modified on those network nodes which have a comparatively increased amount of apparent power. The amount of the complex apparent power is the apparent power, so that the apparent power is increased on these network nodes. This is the case, for example, on network nodes on which an increased feed-in, for example by renewable energy generators, or increased feed-out occurs.

In some embodiments, the errors associated with the states of the first training dataset are determined by a training of the artificial neural network with the first training dataset. In other words, the first training dataset preferably comprises a test dataset and a dataset by means of which the training is performed. The trained ANN is then checked, i.e. evaluated, by means of the test dataset. Said errors are determined here.

If the first training dataset comprises too few or no test data from, it may be effective to divide it into two partial training datasets in order to determine the errors, wherein the first partial training dataset is used to train the artificial neural network, and the second partial training dataset (test dataset) is used to evaluate the states determined by the training. A test dataset can be provided as a result. For example, 70 per cent of the training data are used for training and 30 per cent of the data for testing or for evaluating the states determined by the training.

In some embodiments, the complex apparent powers are formed by active powers and reactive powers associated with the network nodes. In other words, the complex apparent powers are preferably formed by the node active powers and node reactive powers.

In some embodiments, the first measurement dataset and/or second measurement dataset is/are formed by voltages, currents, active powers and/or reactive powers associated with the network nodes and/or with lines of the power network. As a result, the typically used measurement values can be taken into account by the correspondingly trained artificial neural network, i.e. as inputs for determining the state.

In some embodiments, the state of the power network is formed by voltages and angles on one or more network nodes of the power network. The output of the correspondingly trained artificial neural network thus corresponds to a state of the power network as typically defined and used.

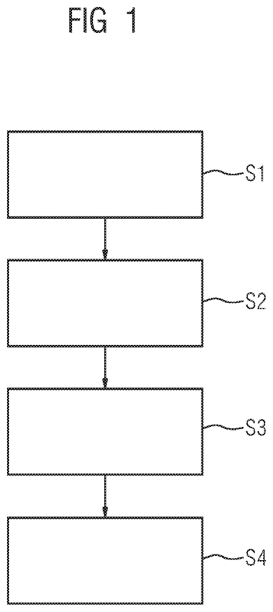

FIG. 1 shows a schematic flow diagram of a method incorporating teachings of the present disclosure. In the method shown for creating a second training dataset for training an artificial neural network designed for a state estimation of a power network from a provided second training dataset, said second training dataset comprising a plurality of training pairs, wherein each of the training pairs is formed by a measurement dataset and an associated state of the power network, and the respective measurement dataset comprises at least complex apparent powers associated with the power network, at least steps S1 to S4 are carried out.

In the first step S1 of the method, at least one first training pair and an associated first measurement dataset and first state are determined, the first state of which has an error greater than or equal to a defined error limit compared with a training of the artificial neural network by means of the first training dataset. These training pairs determined in this way are similarly referred to as critical training pairs or critical scenarios.

In the second step S2 of the method, a second state of the power network is calculated by means of a load flow calculation based on at least one complex apparent power modified in comparison with the complex apparent power of the first measurement dataset. The complex apparent power of a critical training pair can similarly be referred to as a critical complex apparent power.

In the third step S3 of the method, a second measurement dataset is calculated from the calculated second state by means of a measurement model of the power network.

In the fourth step S4 of the method, the second training dataset is created from the first training dataset by adding a second training pair formed from the second measurement dataset and the associated second state. A new training dataset, i.e. the second training dataset, which has more data compared with critical training pairs/scenarios is therefore created by means of steps S1 to S4. As a result, the accuracy of a correspondingly trained artificial neural network is improved in relation to a state estimation of the power network.

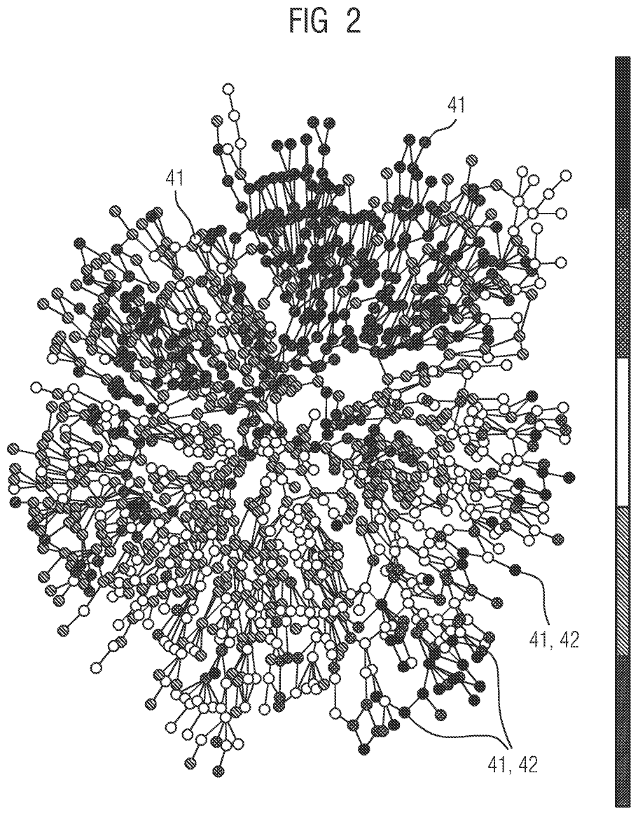

FIG. 2 shows a schematic power network 1 with its associated network nodes 41, wherein, in the interests of clarity, only two network nodes of the power network are indicated by the reference number 41. In other words, FIG. 2 shows a training pair in the sense of the present disclosure and/or one of its designs, wherein only the apparent powers of the associated measurement dataset are shown. In FIG. 2, the network nodes 41 are shaded differently, wherein the different shadings characterize the different values of the apparent power (amount of the complex apparent power). An apparent power is thus associated with each network node 41.

The power network further has network nodes 41 which have a comparatively high apparent power. These network nodes are indicated in the figure additionally by the reference number 42. In other words, these network nodes 42 have an apparent power which is greater than or equal to a defined threshold value. A comparatively high apparent power of this type occurs, for example, due to the feed-in of one or more photovoltaic power installations. In other words, a critical training pair in the sense of the present invention is presented or illustrated in FIG. 2.

The network nodes 42 typically have a comparatively high error in a training of a critical neural network, i.e. their error is greater than or equal to a defined error limit. This is the case, on the one hand, because the network nodes 41 typically have a high variance in terms of the apparent power and/or their state and are furthermore underrepresented within a training dataset.

In some embodiments, at least one apparent power, e.g. of a network node 42, is then modified, for example by adding a normally distributed random number. A new power network 1 comparable with the presented figure, having at least one, preferably a plurality of apparent powers, is formed as a result. A new state is then determined by means of a load flow calculation and a new measurement dataset is generated from the new state by means of a measurement model of the power network 1. The new state and the new measurement dataset form a new training pair which can be used to train an ANN.

Although the teachings herein have been illustrated and described in detail by means of the example embodiments, the scope of the disclosure is not restricted to the disclosed examples, or other variations can be derived by the person skilled in the art therefrom without departing the scope of the disclosure.

### REFERENCE NUMBER LIST

S1 First step

S2 Second step

S3 Third step

S4 Fourth step

1 Power network

41 Network node

42 Critical network node

1. A method for creating a second training dataset for training an artificial neural network designed for a state estimation of a power network from a provided first training dataset, said second training dataset comprising a plurality of training pairs, wherein each of the training pairs is formed by a measurement dataset and an associated state of the power network, and the respective measurement dataset comprises complex apparent powers associated with the power network, the method comprising:
determining a first training pair and an associated first measurement dataset and first state, the first state having an error greater than or equal to a defined error limit compared with a training of the artificial neural network using the first training dataset;
calculating a second state of the power network using a load flow calculation using a complex apparent power modified in comparison with the complex apparent power of the first measurement dataset;
calculating a second measurement dataset from the calculated second state using a measurement model of the power network; and
creating the second training dataset from the first training dataset by adding a second training pair formed from the second measurement dataset and the associated second state.

2. The method as claimed in claim 1, further comprising generating the training pairs of the first training dataset using a load flow calculation.

3. The method as claimed in claim 2, further comprising generating the training pairs from synthetically generated complex apparent powers using a respective load flow calculation;
wherein the complex apparent powers are generated from historical and/or synthetic time series for generation and consumption.

4. The method as claimed in claim 1, further comprising modifying the complex apparent power of the first measurement dataset using an addition of normally distributed random numbers.

5. The method as claimed in claim 1, further comprising modifying the complex apparent power of the first measurement dataset using a scaling.

6. The method as claimed in claim 1, further comprising modifying one of the complex apparent powers of the first measurement dataset if its amount is greater than or equal to a defined threshold value.

7. The method as claimed in claim 1, further comprising determining errors associated with the states of the first training dataset by training the artificial neural network with the first training dataset.

8. The method as claimed in claim 7, characterized in that the first training dataset is divided into two partial training datasets in order to determine the errors, wherein the first partial training dataset is used to train the artificial neural network, and the second partial training dataset is used to evaluate the states determined by the training.

9. The method as claimed in claim 1, further comprising forming the complex apparent powers using active powers and reactive powers associated with the network nodes.

10. The method as claimed in claim 1, further comprising forming the first measurement dataset and/or second measurement dataset using voltages, currents, active powers, and/or reactive powers associated with the network nodes and/or with lines of the power network.

11. The method as claimed in claim 1, further comprising forming the state of the power network using voltages and angles on one or more network nodes of the power network.

12. The method as claimed in claim 1, further comprising training an artificial neural network for a state estimation of a power network using the second training dataset.

13. A method for the state estimation of a power network, the method comprising:
using an artificial neural network with measurement values associated with the power network as inputs and the estimated state of the power network to be determined by the state estimation as output;
wherein the artificial neural network is trained with a second training dataset, said second training dataset comprising a plurality of training pairs, wherein each of the training pairs is formed by a measurement dataset and an associated state of the power network, and the respective measurement dataset comprises complex apparent powers associated with the power network;
wherein creating the second data set includes:
determining a first training pair and an associated first measurement dataset and first state, the first state having an error greater than or equal to a defined error limit compared with a training of the artificial neural network using the first training dataset;
calculating a second state of the power network using a load flow calculation using a complex apparent power modified in comparison with the complex apparent power of the first measurement dataset;
calculating the second measurement dataset from the calculated second state using a measurement model of the power network; and
creating the second training dataset from the first training dataset by adding a second training pair formed from the second measurement dataset and the associated second state.

14. The method as claimed in claim 13, further comprising using measured voltages, currents, active powers, and/or reactive powers associated with network nodes and/or with lines of the power network as measurement values.
